(19) United States
(12) Patent Application Publication
(10) Pub. No.: US 2014/0172579 A1
(43) Pub. Date: Jun. 19, 2014

(54) SYSTEMS AND METHODS FOR MONITORING USERS VIEWING MEDIA ASSETS

(71) Applicant: UNITED VIDEO PROPERTIES, INC., Santa Clara, CA (US)

(72) Inventors: Brian Peterson, Barrington, IL (US); Paul Jensen, Menlo Park, CA (US); Charles Dawes, Ryton (GB)

(73) Assignee: UNITED VIDEO PROPERTIES, INC., Santa Clara, CA (US)

(21) Appl. No.: 13/716,733

(22) Filed: Dec. 17, 2012

(51) Int. Cl. G06Q 30/02

(52) U.S. Cl. CPC G06Q 30/0269
USPC 705/14.66

(57) ABSTRACT

Methods and systems are described herein for monitoring a user accessing a media asset, determining an attentiveness level of the user, and in response to determining that the attentiveness level is above a threshold level, transmitting an instruction to display an advertisement on a display device. By transmitting the advertisement only when a user meets a threshold level of attentiveness, a media application may guarantee to a content/advertisement provider that an advertisement was viewed by the user.

### BACKGROUND

In conventional systems, advertisements presented to users provide the funding means for a variety of media assets. Television broadcasts, streaming internet media, and even some on-demand programs are supported by advertisements shown during their play lengths. To prevent users from becoming irritated, or from losing interest in the program, advertisements are typically displayed only during advertisement breaks. Each advertisement break typically shows several advertisements and lasts for a few minutes.

The length and point of insertion of advertisements is often a delicate balancing act for the content provider. For example, if a content provider provides all the advertisements after the media assets, the provider risks that the user will change channels or select a new media asset before viewing the advertisements. Likewise, if a content provider provides all the advertisements before the media asset, the provider risks that the user will lose interest and stop viewing the remaining advertisements and/or the media asset.

In an effort to prevent users from changing channels or switching to other media assets, conventional systems often distribute the advertisements throughout the play length of the media asset. For example, in broadcast television, advertisements typically occur at the fifteen and thirty minute marks of a thirty minute program. However, even distributing the advertisements throughout the media asset does not guarantee that a user is paying attention to the advertisements during them, or even ensure that the user has not left the room in which the advertisement is displayed.

### SUMMARY OF THE DISCLOSURE

Accordingly, methods and systems are described herein for monitoring a user accessing a media asset, determining an attentiveness level of the user, and in response to determining that the attentiveness level is above a threshold level, transmitting an instruction to display an advertisement on a display device. By transmitting an advertisement only when a user meets a threshold level of attentiveness, a media application may guarantee to a content/advertisement provider that an advertisement was viewed by the user.

In some embodiments, the media application may incorporate, or have access to, a detection module, which may incorporate various content capture devices and/or content recognition applications and algorithms capable of detecting and identifying various types of data that media application may use to compute an attentiveness level associated with a user. For example, the media application may detect the number of individual users and whether or not the individual users are looking at the display device featuring the media assets and/or advertisements. The media application may use data associated with whether or not the users are viewing the media asset as well as additional data (e.g., data associated with whether or not the users are listening to the display device, interacting with the display device, interacting with another device, or interacting with other users, etc.) to compute an attentiveness level of the user. In some embodiments, the detected attentiveness level of a user or the number of users in the viewing area may also be used to initiate dynamic advertisement breaks so that advertisements are displayed only when users are attentive and present.

In some embodiments, the media application may also interpret advertisement data, including but not limited to, advertisement rules, associated with each advertisement. An advertisement rule may define whether or not an advertisement is initiated (or terminated) based on the attentiveness level of one or more users. For example, the media application may not transmit an instruction to display an advertisement until one or more users is paying attention (e.g. as determined by an eye contact detection component incorporated into a detection module accessible by the media application) to the display device.

An advertisement rule may also define whether or not one advertisement is displayed versus another advertisement in an advertisement break. For example, the advertisement rule associated with an advertisement may require a threshold number of users to be present before the advertisement is displayed. If a threshold number of users is not present, the media application may select a different advertisement, which may have a lower threshold number of users.

An advertisement rule may also define the look and feel of an advertisement. For example, based on the attentiveness level of a user, the media application may select a longer or shorter version of the advertisement, a high quality or low quality version of the advertisement, or a version of an advertisement with more or less additional content (e.g., an on-screen pop-up featuring a coupon code).

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a viewing area from which a media application may determine an attentiveness level associated with each user in accordance with some embodiments of the disclosure;

FIG. 2 shows another illustrative example of a viewing area from which the media application may determine an attentiveness level associated with each user in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is an illustrative example of one component of a detection module, which may be accessed by a media application in accordance with some embodiments of the disclosure;

FIG. 6 is an illustrative example of a data structure that may be used to transmit data generated by the media application that is associated with an attentiveness level of a user in accordance with some embodiments of the disclosure;

FIG. 7 is a flowchart of illustrative steps for determining whether or not to transmit an instruction to display an advertisement based on a comparison of an attentiveness level of a user and a threshold attentiveness level associated with the advertisement in accordance with some embodiments of the disclosure;

FIG. 8 is a flowchart of illustrative steps for determining an attentiveness level of a user in accordance with some embodiments of the disclosure; and

FIG. 9 is a flowchart of illustrative steps for determining whether or not to transmit an instruction to display an advertisement based on interpreting one or more advertisement rules associated with the advertisement.

### DETAILED DESCRIPTION OF DRAWINGS

Methods and systems are described herein for a media application capable of monitoring a user accessing a media asset, determining an attentiveness level of the user, and in response to determining that the attentiveness level is above a threshold level, transmitting an instruction to display the advertisement on a display device. By transmitting an advertisement only when a user meets a threshold level of attentiveness, a media application may guarantee to a content/advertisement provider that an advertisement was viewed by the user.

Media applications may take various forms depending on their function. Some media applications generate graphical user interface screens (e.g., that enable a user to navigate among, locate and select content), and some media applications may operate without generating graphical user interface screens (e.g., while still issuing instructions related to the transmission of media assets and advertisements).

As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “display device,” “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same.

In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media applications may be provided as on-line applications (i.e., provided on a web-site), or as stand-alone applications or clients on user equipment devices. Various devices and platforms that may implement media applications are described in more detail below.

As used herein, an “attentiveness level” is a quantitative or qualitative analysis of the level of attention that a user is giving a media asset, including, but not limited to, an advertisement. For example, an attentiveness level may represent a numerical amount or score computed based on one or more types of data describing the user or users currently within a viewing area of a user device with which the media application is associated. In some embodiments, the attentiveness level may be normalized (e.g., in order to represent a number between one and one-hundred). In some embodiments, the attentiveness level may be described as a percentage (e.g., of a user's total amount of attention). In some embodiments, the attentiveness level may be described as a positive (e.g., “attentive”) or negative (e.g., “non-attentive”) designation.

In some embodiments, the attentiveness level of a user may be computed before, during, or after a media assets and/or advertisement. Furthermore, any embodiment in this disclosure referring to computing an attentiveness level before, during, or after a media asset may also be applied to computing an attentiveness level before, during, or after an advertisement. For example, the media application may compute an attentiveness level of a user during the display of a media asset, but before the display of an advertisement, in order to determine whether or not an advertisement should be displayed.

Additionally or alternatively, the media application may compute an attentiveness level of a user after the display of a media asset and during (or after) the display of an advertisement, in order to determine whether or not an advertisement should continued to be displayed (or whether or not the user viewed the advertisement). For example, in some embodiments, a content/advertisement provider may wish to know whether a particular advertisement was viewed, and/or with what attentiveness level, by a user. In some embodiments, a content/advertisement provider may offer enticements (e.g., on-screen pop-ups featuring coupon code), in response to a user dedicating his/her attention to an advertisement.

In some embodiments, the attentiveness level may be based on receiving one or more types of data. For example, the attentiveness level may be determined based on data associated with whether or not the user is viewing the display device upon which a media asset is accessed, data associated with whether the user is listening to the display device upon which a media asset is accessed, data associated with whether the user is interacting with the display device upon which a media asset is accessed, data associated with whether the user is interacting with another device upon which the media asset is not accessed, data associated with whether the user is interacting with another user, whether or not the interaction regards the media asset, or any other information that may be used by the media application to influence the attentiveness level that the media application associates with one or more users.

For example, the presence, or amount of, any type of data may influence (e.g., increase, decrease, or maintain) an attentiveness level of a user as determined by the media application. For example, if the media application determines the user is making eye contact with the display device displaying the media asset, the media application may increase an attentiveness level associated with the user as eye contact is indicative of a user devoting his/her attention to the media asset. Likewise, if the media application determines the user is engaged in a conversation with other users or is interacting with a second user device (e.g., a smartphone), the media application may decrease an attentiveness level associated with the user as being engaged in a conversation indicates the user is distracted from the media asset.

In some embodiments, whether data influences an attentiveness level of a user positively or negatively, or the amount that the data influences the attentiveness level of a user, may depend on the context of the data received and/or generated by the media asset. For example, as stated above, if the media application determines the user is engaged in a conversation with other users or is interacting with a second user device (e.g., a smartphone), the media application may decrease an attentiveness level associated with the user or users. However, if the media application determines that the conversation concerns the media asset (e.g., two users are discussing a recent plot twist) or determines the second user device is accessing content associated with a media asset (e.g., ordering information associated with a displayed advertisement), the media application may increase an attentiveness level associated with the user or users.

In some embodiments, the media application may determine a composite attentiveness level of several users. As used herein, a “composite attentiveness level” is a level of attentiveness of a plurality of users that represents a statistical analysis (e.g., a mean, median, mode, etc.) of the individual attentiveness levels of each user in the plurality of users. For example, in some embodiments, an advertisement rule associated with an advertisement may define conditions related to a composite attentiveness level instead of an attentiveness level associated with a single user. It should be noted, therefore, that any embodiment or description relating to, or using, an attentiveness level associated with a single user may also be applied to composite attentiveness level of several users.

To determine an attentiveness level of a user, in some embodiments, a media application (e.g., in some cases via a detection module incorporated into or accessible by the media application) may use a content recognition module or algorithm to generate data describing the attentiveness of a user. The content recognition module may use object recognition techniques such as edge detection, pattern recognition, including, but not limited to, self-learning systems (e.g., neural networks), optical character recognition, on-line character recognition (including but not limited to, dynamic character recognition, real-time character recognition, intelligent character recognition), and/or any other suitable technique or method to determine the attentiveness of a user. For example, the media application may receive data in the form of a video. The video may include a series of frames. For each frame of the video, the media application may use a content recognition module or algorithm to determine the people (including the actions associated with each of the people) in each of the frame or series of frames.

In some embodiments, the content recognition module or algorithm may also include speech recognition techniques, including but not limited to Hidden Markov Models, dynamic time warping, and/or neural networks (as described above) to translate spoken words into text and/or processing audio data. The content recognition module may also combine multiple techniques to determine the attentiveness of a user. For example, a video detection component of the detection module may generate data indicating that two people are within a viewing area of a user device. An audio component of the detection module may generate data indicating that the two people are currently engaged in a conversation about the media assets (e.g., by determining and processing keywords in the conversation). Based on a combination of the data generated by the various detection module components, the media application may compute an attentiveness level for the two people within the viewing area.

In addition, the media application may use multiple types of optical character recognition and/or fuzzy logic, for example, when processing keyword(s) retrieved from data (e.g., textual data, translated audio data, user inputs, etc.) describing the attentiveness of a user (or when cross-referencing various types of data in databases). For example, if the particular data received is textual data, using fuzzy logic, the media application (e.g., via a content recognition module or algorithm incorporated into, or accessible by, the media application) may determine two fields and/or values to be identical even though the substance of the data or value (e.g., two different spellings) is not identical. In some embodiments, the media application may analyze particular received data of a data structure or media asset frame for particular values or text using optical character recognition methods described above in order to determine the attentiveness of a user. The data received could be associated with data describing the attentiveness of the user and/or any other data required for the function of the embodiments described herein. Furthermore, the data could contain values (e.g., the data could be expressed in binary or any other suitable code or programming language).

In some embodiments, the media application may use multiple sources and/or methods to determine the attentiveness of a user or when selecting, recommending, and/or transmitting media assets, including advertisements, to a user device. For example, the media application may cross-reference one or more databases that contain information about the media assets and/or types of media assets preferred by a user or users on a particular user device. Although the data may not be generated by a detection module, the data may still influence the attentiveness level the media application associates with the user. For example, if a user profile indicates that a particular user prefers a particular media asset, the media application may increase the attentiveness level of the user, even without information generated by a detection module related to the actions (or presence) of the user.

In some embodiments, the media application may also interpret advertisement data containing advertisement rules associated with advertisements. As used herein, an “advertisement rule” defines the criteria related to the decision and circumstances associated with the selection and display of one or more advertisements. For example, an advertisement rule may indicate to the media application whether or not an advertisement, or a series of advertisements (e.g., in a commercial break) is initiated (or terminated) based on the attentiveness level of one or more users. An advertisement rule may also define whether or not one advertisement is displayed versus another advertisement. For example, the advertisement rule associated with an advertisement may require a threshold number of users to be present before the advertisement is displayed. If a threshold number of users is not present, the media application may select a different advertisement, which may have a lower threshold number of users.

An advertisement rule may also define a threshold attentiveness level associated with an advertisement. As used herein, a “threshold attentiveness level” refers to an attentiveness level of a user or users that must be met or exceeded in order for advertisement to be display. An advertisement rule may also define a threshold number of users associated with an advertisement. As used herein, a “threshold number of users” refers to a number of users within the viewing area of a display device that must be met or exceeded in order for advertisement to be display. For example, an advertisement rule associated with an advertisement may indicate that the advertisement should only be displayed if five or more users are within the viewing area of the display device.

As used herein, a “viewing area” refers to a finite distance from a display device typically associated with an area in which a user may be capable of viewing media assets and/or advertisements on the display device. In some embodiments, the size of the viewing area may vary depending on the particular display device. For example, a display device with a large screen size may have a greater viewing area than a display device with a small screen size. In some embodiments, the viewing area may correspond to the range of the detection modules associated with the media application. For example, if the detection module can detect a user only within five feet of a display device, the viewing area associated with the display device may be only five feet. Various systems and methods for detecting users within a range of a media device, is discussed in, for example, Shimy et al., U.S. patent application Ser. No. 12/565,486, filed Sep. 23, 2009, which is hereby incorporated by reference herein in its entirety.

The advertisement data and/or rules may be stored locally or remotely, and may be stored either together or separately from its associated advertisement and/or any other advertisement data and/or rules associated with a different media asset. For example, in some embodiments, an advertisement may be stored on a remote server (e.g., content source 416 (FIG. 4)) and advertisement data and/or rules associated with the advertisement may be stored on a different remote server (e.g., advertisement data source 418 (FIG. 4)).

An advertisement rule may also define the look and feel of an advertisement that is selected and/or transmitted. In some embodiments, the media assets and/or advertisements that may be selected and/or transmitted to a user may be associated with an advertisement rule that defines the content, context, or target user, device, and/or attentiveness level for the media asset. For example, based on the attentiveness level of a user or the number of users within a viewing range, an advertisement rule interpreted by the media application may determine that a longer or shorter version of the advertisement, a high quality or low quality version of the advertisement, or a version of an advertisement with more or less additional content (e.g., an on-screen pop-up featuring a coupon code) is displayed.

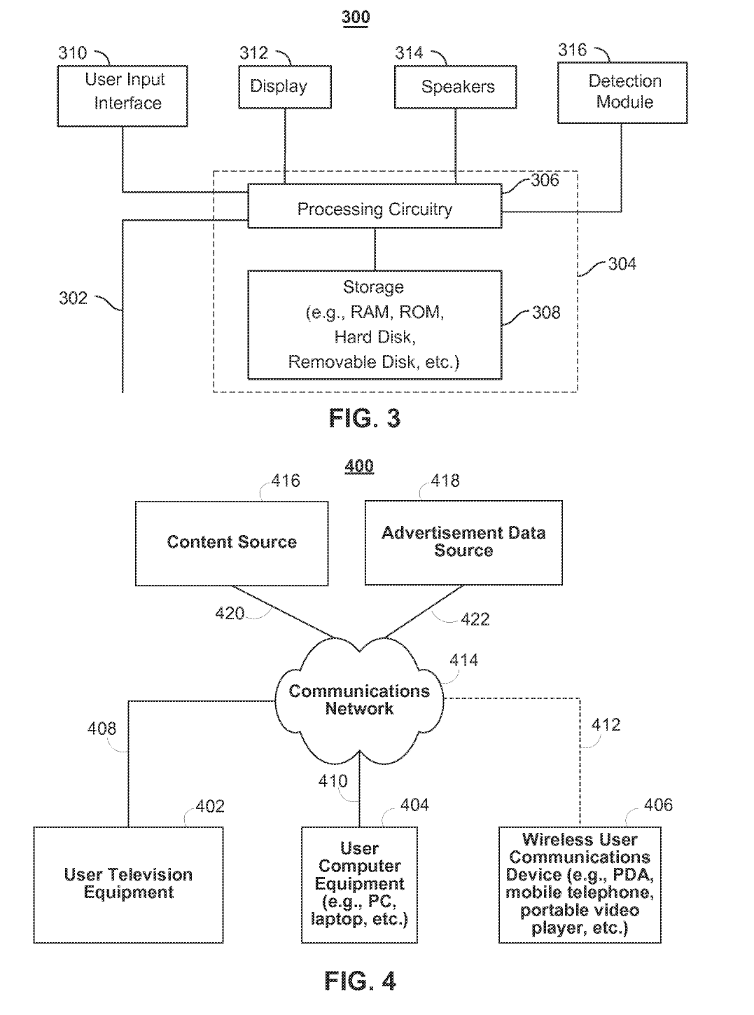

In another example, an advertisement rule associated with an advertisement may define the content (e.g., the genre, rating, etc.) of the advertisement. In response, the media application may issue a request for, or retrieve (e.g., via processing the advertisement rule associated with the advertisement using control circuitry 304 (FIG. 3)), an advertisement that is appropriate for a particular device, user, and/or attentiveness level. For example, a remote server hosting the advertisement and/or the advertisement rule associated with the advertisement may receive instructions (e.g., requirements for an advertisement) from a media application describing the advertisement that is needed (e.g., based on the user, device, and/or attentiveness level). The server may cross-reference a database of various advertisement rules associated with various advertisements until an advertisement rule having the requested requirements is located. The located advertisement may then be transmitted to the media application for display in the user device.

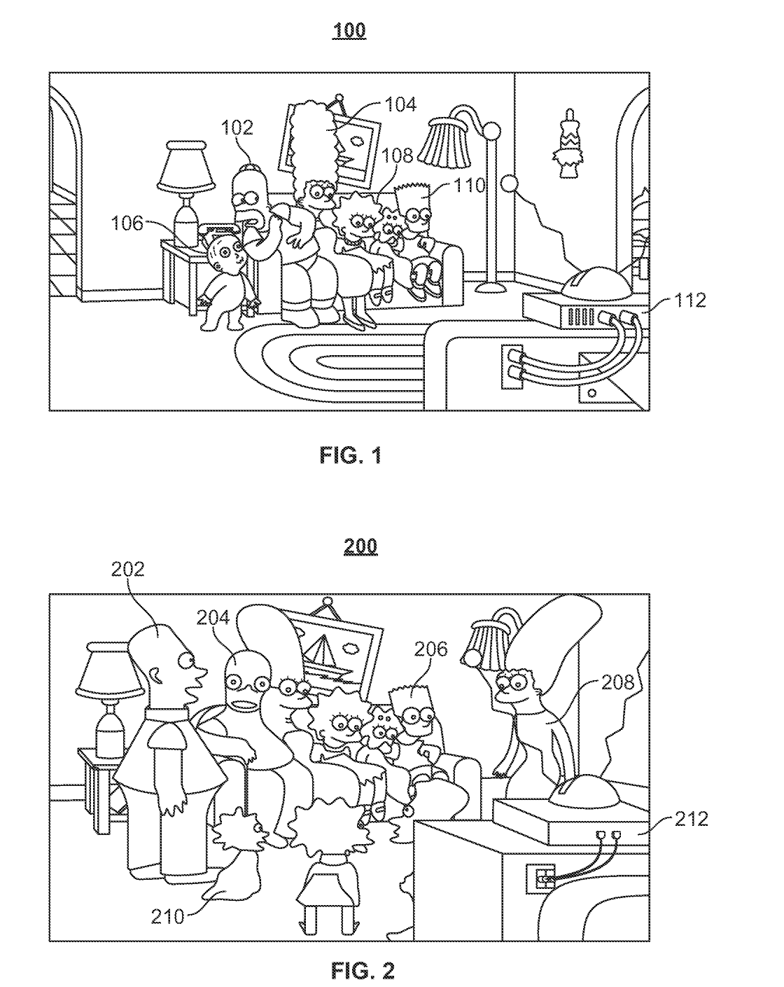

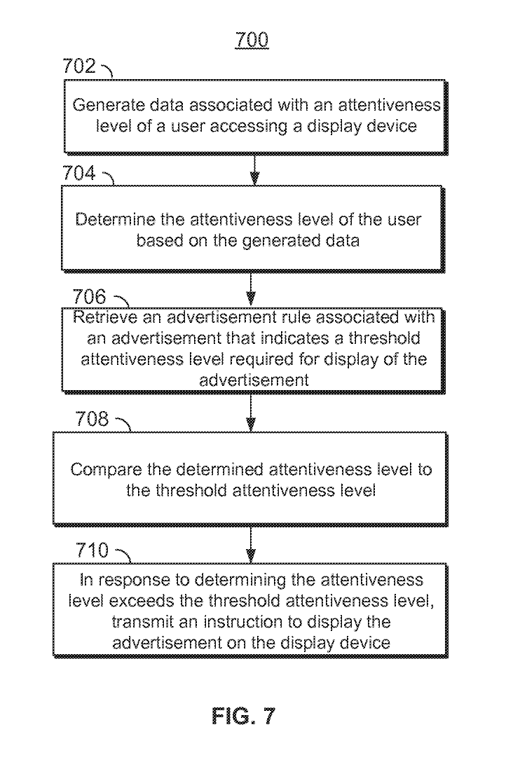

FIG. 1 shows an illustrative example of a viewing area from which a media application may determine an attentiveness level associated with each user in accordance with some embodiments of the disclosure. Viewing area 100 illustrates a viewing area featuring a plurality of users (e.g., user 102, user 104, user 106, user 108, and user 110) that a media application may analyze to determine whether or not to display an advertisement on a display device (e.g., display device 112) as discussed in relation to FIGS. 7-9 below.

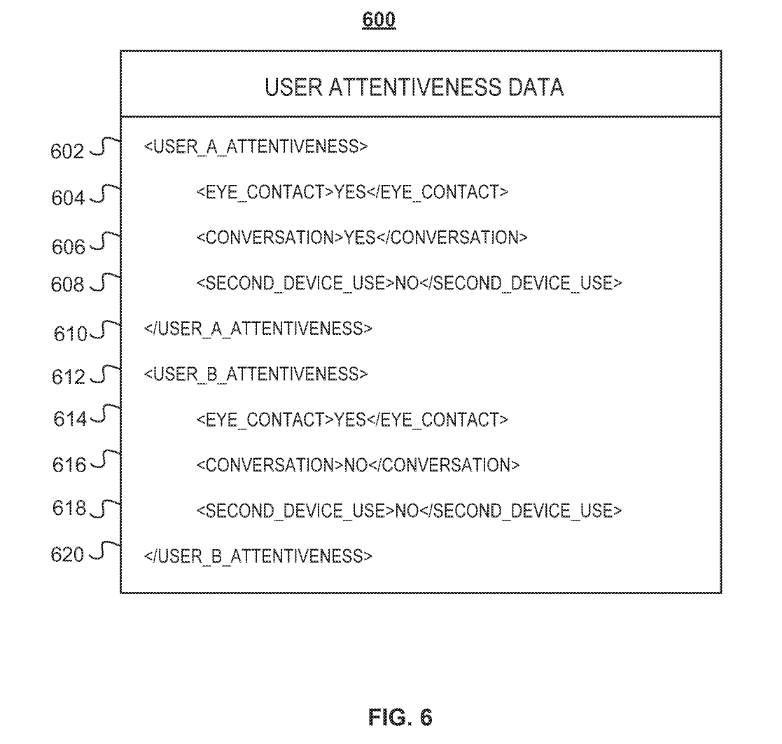

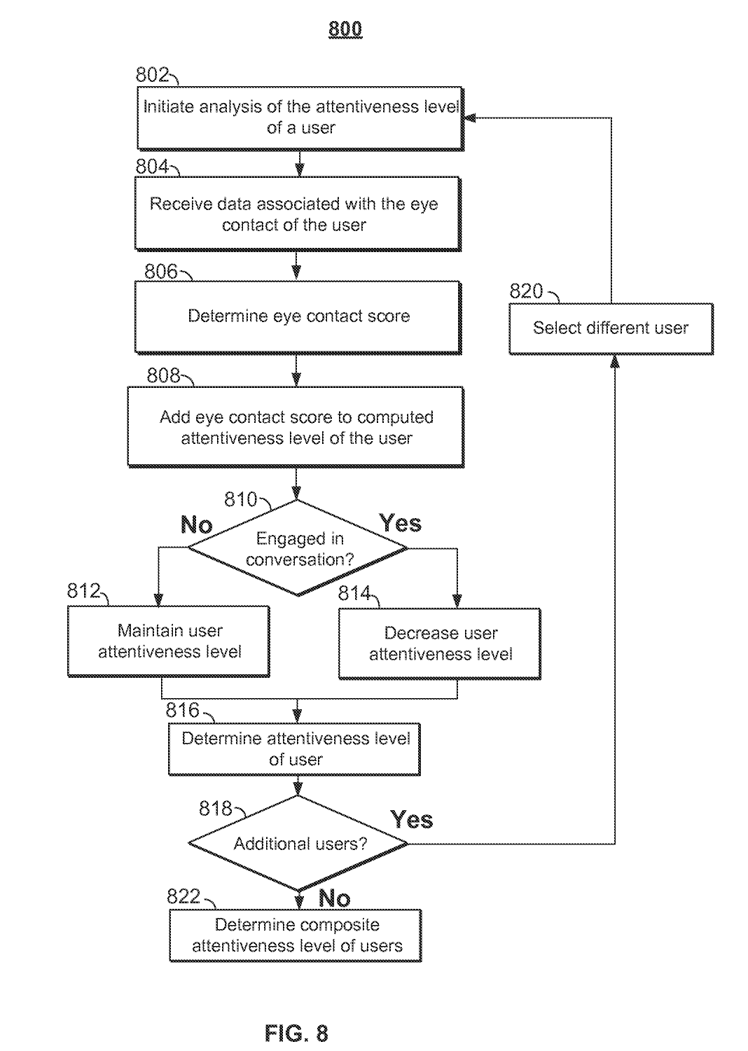

In some embodiments, a media application (e.g., implemented on display device 112) may determine the attentiveness level of each of the plurality of users in viewing area 100. Based on the characteristics and actions (e.g., whether or not the users are distracted from the media asset and/or advertisement) of each of the users, the media application determines an attentiveness level for each of the users (e.g., as described below in FIG. 6). In some embodiments, the attentiveness level for each user in viewing area 100 may be combined to generate a composite attentiveness level as described in FIG. 8 below.

In viewing area 100, a plurality of users are currently viewing a media asset displayed on display device 112 (e.g., user equipment device 402, 404, and/or 406 (FIG. 4)). In order to determine whether or not to display an advertisement, the media application may generate data associated with the attentiveness of each of the users (e.g., user 102, user 104, user 106, user 108, and user 110) via a detection module (e.g., detection module 316 (FIG. 3)) incorporated into, or accessible by, the media application. In some embodiments, the detection module may include multiple components capable of generating data, of various types, indicating the attentiveness level of each user.

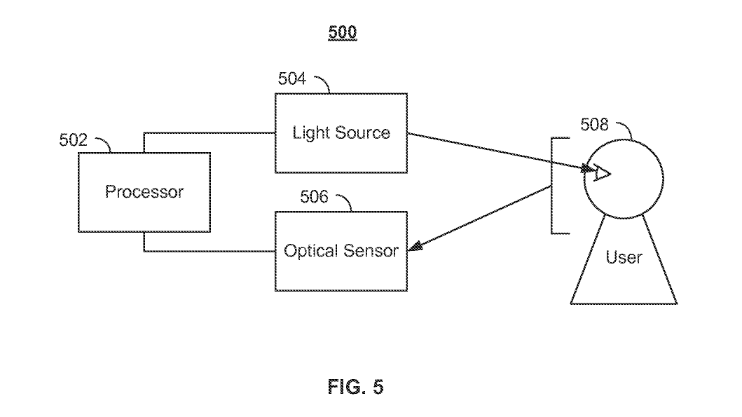

For example, a video detection component may detect the number of users and identity (e.g., in order to associate each user with a user profile as discussed above) of each of the users within viewing area 100, an audio detection module may determine user 102 and user 106 are currently engaged in a conversation, and an eye contact detection component (e.g., as described in FIG. 5 below) may determine that each of the users is currently making eye contact with display device 112. Based on this data, the media application may determine an attentiveness level for each of the users (e.g., as discussed below in relation to FIG. 7).

For example, when computing an attentiveness level for each of the users (e.g., as discussed in FIG. 8 below), the media application may increase the determined attentiveness level for each user because each user is currently making eye contact with the display device featuring the media asset. In addition, the media application may decrease the attentiveness level of user 102 and user 106 because they are currently engaged in a conversation. In addition, if the advertisement rule relates to a threshold number of users, the media application may determine the number of users (e.g., as determined by the video detection component) is six users.

For example, viewing area 100 may represent a group of users (e.g., user 102, user 104, user 106, user 108, and user 110) viewing an important event (e.g., the National Football League's Superbowl) on a display device (e.g., display device 112). Due to the cost to an advertiser to advertise during such an important event as well as the production costs associated with producing the advertisement, the advertiser may want assurance that the advertisement will be displayed only when a threshold number of users or when the users have a threshold attentiveness level. Therefore, upon detecting an advertisement break, the media application may compare the advertisement rules (e.g., indicating a threshold attentiveness level of the users or a threshold number of users) necessary for displaying the advertisement (e.g., as described in relation to FIGS. 7-9 below). Upon determining that the current attentiveness level of the users or the current number of users within the viewing area equals or exceeds the requirements of the advertisement rules, the media application may issue (e.g., via control circuitry 304 (FIG. 3)) an instruction to transmit the advertisement to the display device.

It should be noted that the embodiments of this disclosure are not limited to any particular display device (e.g., a television) or any particular location (e.g., a private residence) of a display device. In some embodiments, the methods and systems of this disclosure may be adapted for use with various types of display devices and locations.

For example, the media application may be adapted to be implemented in a movie theatre setting. The media application may process the advertisement rules associated with several advertisements (e.g., stored on a local database such as storage 308 (FIG. 3) or a remote database such as advertisement data source 418 (FIG. 4)) in order to determine what, if any, advertisements should be displayed before, during, or after a movie (e.g., based on the current attentiveness level of the users within the viewing area, the current number of users within the viewing area, or any other requirement dictated by the advertisement rules). If the attentiveness level of the users or the number of users is high (e.g., immediately prior to the beginning of the movie), the media guidance application may transmit an instruction to display one advertisement (e.g., associated with an advertisement rule requiring a high attentiveness level or high number of users), and if the attentiveness level of the users or the number of users is low (e.g., several minutes before the beginning of the movie before most patrons have arrived), the media guidance application may transmit an instruction to display a different advertisement (e.g., associated with an advertisement rule allowing display even with a low attentiveness level or low number of users).

In another example, the media application may be adapted to be implemented on a billboard. The media application may process the advertisement rules associated with several advertisements (e.g., stored on a local database such as storage 308 (FIG. 3) or a remote database such as advertisement data source 418 (FIG. 4)) in order to determine what, if any, advertisements should be displayed based on the attentiveness of users or the number of vehicles or pedestrians detected within the viewing area by a detection module (e.g., detection module 316 (FIG. 3)). If the attentiveness level of the users or the number of vehicles or pedestrians is high, the media guidance application may transmit an instruction to display one advertisement (e.g., associated with an advertisement rule requiring a high attentiveness level or high number of vehicles or pedestrians), and if the attentiveness level of the users or the number of vehicles or pedestrians is low, the media guidance application may transmit an instruction to display a different advertisement (e.g., associated with an advertisement rule allowing display even with a low attentiveness level or low number of vehicles or pedestrians).

In another example, the media application may be adapted to be implemented during live events (e.g., a sporting event). The media application, implemented on a scoreboard or other display in the venue, may process the advertisement rules associated with several advertisements (e.g., stored on a local database such as storage 308 (FIG. 3) or a remote database such as advertisement data source 418 (FIG. 4)) in order to determine what, if any, advertisements should be displayed during the event. For example, during on-going plays or performances the attentiveness level of the users within the viewing area on the display may be minimal. However, during a timeout or between acts, the attentiveness level of the users within the viewing area may focus on the scoreboard triggering the display (e.g., based on one or more advertisement rules) of an advertisement. For example, if the attentiveness level of the users is high (e.g., between acts), the media guidance application may transmit an instruction to display one advertisement (e.g., associated with an advertisement rule requiring a high attentiveness level), and if the attentiveness level of the users or the number of users is low (e.g., during the performance), the media guidance application may transmit an instruction to display a different advertisement (e.g., associated with an advertisement rule allowing display even with a low attentiveness level).

In another example, the media application may be adapted to be implemented on a mobile device or computer. The media application may process the advertisement rules associated with several advertisements (e.g., stored on a local database such as storage 308 (FIG. 3) or a remote database such as advertisement data source 418 (FIG. 4)) in order to determine what, if any, advertisements should be displayed while the device is idle (e.g., corresponding to a low current attentiveness level of the user) or in use (corresponding to a high current attentiveness level of the user). For example, advertisements requiring a low attentiveness level may be displayed as a screen saver while the device is not in use. Upon detecting the device is in use (e.g., via receiving a user input through user input interface 310 (FIG. 3)), the media application may initiate an advertisement requiring a high current attentiveness level before or while the user uses the device.

In another example, the media application may be adapted to be implemented in an e-book or other computer device. The media application may process the advertisement rules associated with several advertisements (e.g., stored on a local database such as storage 308 (FIG. 3) or a remote database such as advertisement data source 418 (FIG. 4)) in order to determine what, if any, advertisements should be displayed based on the current attentiveness level of the users (e.g., as indicated by the rate at which a user finishes a section of the e-book or browses web-pages). For example, if the attentiveness level of the users or the number of users is high (e.g., the user quickly reads each section), the media guidance application may transmit an instruction to display one advertisement (e.g., associated with an advertisement rule requiring a high attentiveness level), and if the attentiveness level of the users or the number of users is low (e.g., the user is slow to read each section), the media guidance application may transmit an instruction to display a different advertisement (e.g., associated with an advertisement rule allowing display even with a low attentiveness level).

In another example, the media application may be adapted to be implemented on a display in public transportation (e.g., a plane, bus, subway, elevator, etc.). The media application may process the advertisement rules associated with several advertisements (e.g., stored on a local database such as storage 308 (FIG. 3) or a remote database such as advertisement data source 418 (FIG. 4)) in order to determine what, if any, advertisements should be displayed while a user is using the public transportation (e.g., based on the current attentiveness level of the users within the viewing area, the current number of users within the viewing area, or any other requirement dictated by the advertisement rules). If the attentiveness level of the users or the number of users is high, the media guidance application may transmit an instruction to display one advertisement (e.g., associated with an advertisement rule requiring a high attentiveness level or high number of users), and if the attentiveness level of the users or the number of users is low, the media guidance application may transmit an instruction to display a different advertisement (e.g., associated with an advertisement rule allowing display even with a low attentiveness level or low number of users).

In another example, the media application may be adapted to be implemented on walls, signs, kiosks, etc. in public places displaying information (e.g., mall maps, sign posts, descriptions adjoining landmarks/historical places, etc.). The media application may process the advertisement rules associated with several advertisements (e.g., stored on a local database such as storage 308 (FIG. 3) or a remote database such as advertisement data source 418 (FIG. 4)) in order to determine what, if any, advertisements should be displayed based on whether or not a user is currently viewing the wall, sign, kiosk, etc. or any other requirement dictated by the advertisement rules. If the attentiveness level of the users or the number of users is high, the media guidance application may transmit an instruction to display one advertisement (e.g., associated with an advertisement rule requiring a high attentiveness level or high number of users), and if the attentiveness level of the users or the number of users is low, the media guidance application may transmit an instruction to display a different advertisement (e.g., associated with an advertisement rule allowing display even with a low attentiveness level or low number of users).

FIG. 2 shows another illustrative example of a viewing area from which the media application may determine an attentiveness level associated with each user in accordance with some embodiments of the disclosure. Viewing area 200 illustrates another viewing area featuring another plurality of users (e.g., user 202, user 204, user 206, user 208, and user 210) that a media application may analyze to determine whether or not to display an advertisement on a display device (e.g., display device 212) as discussed in relation to FIGS. 7-9 below.

In viewing area 200, not all users are currently viewing a media asset displayed on display device 212 (e.g., user equipment device 402, 404, and/or 406 (FIG. 4)). For example, user 202, user 204, user 206, user 208, and user 210 are not currently looking at display device 212. Therefore, in some embodiments, the media application may compute a lower attentiveness level for each of those users. For example, a detection module (e.g., detection module 316 (FIG. 3)) may determine that user 202, user 204, user 206, user 208, and user 210 are not currently making eye contact with the display device and are thus not viewing the media asset and/or advertisement. Therefore, when computing an attentiveness level for each of the users (e.g., as discussed in FIG. 8 below), the media application may decrease the determined attentiveness level for each user because each of those users is not currently making eye contact with the display device featuring the media asset.

In some embodiments, the media guidance application may monitor whether or not and/or when one advertisement was displayed. For example, during an advertisement break one advertisement may not have been selected for display (e.g., the attentiveness level of the users was too low or the number of users within the viewing area was too low). Therefore, the media guidance application may attempt to reschedule the display of that advertisement. For example, the users (e.g., user 202, user 204, user 206, user 208, and user 210) in viewing area 200 may not have had the required attentiveness level of an advertisement or the required number of users within the viewing area (e.g., as defined by an advertisement rule associated with the advertisement) when the advertisement was initially scheduled to be displayed. Therefore, the media guidance application (e.g., via control circuitry 304 (FIG. 3)) may record (e.g., in a local database such as storage 308 (FIG. 3) or in a remote database such as advertisement data source 418 (FIG. 4)) that the advertisement was not displayed.

The media guidance application may then hold the advertisement in queue until the media guidance application determines (e.g., via detection module 316 (FIG. 3)) that the attentiveness level of the users (e.g., user 202, user 204, user 206, user 208, and user 210) within the viewing area (e.g., viewing area 200) equals or exceeds (e.g., as discussed below in relation to FIG. 7) the threshold attentiveness level of the advertisement rule associated with the advertisement.

In some embodiments, the media guidance application may also insert dynamic advertisement breaks into a media asset. An advertisement break refers to an interruption in the progression of a media asset in order to display one or more advertisements. In some embodiments, an advertisement break may be initiated by a content provider (e.g., the content provider schedules advertisement breaks to automatically occur at specific points during the progression of the media asset), and in some embodiments, the media guidance application may initiate dynamic advertisement breaks.

For example, in some embodiments in which the advertisement breaks are initiated by a content provider, the media guidance application relies on the content provider to determine when to initiate an advertisement. For example, the media guidance application may depend on detecting triggers in the data stream delivering the media asset, may depend on detecting fades-to-black commonly associated with advertisement breaks, or may receive a signal indicating the change from the content provider (e.g., content source 416 (FIG. 4)). Upon detecting the scheduled advertisement break, the media guidance application may retrieve advertisement data, including an advertisement rule, in order to determine whether or not to transmit an instruction to display a particular advertisement (e.g., as discussed in relation to FIG. 7 below).

In contrast, in dynamic advertisement breaks, the media guidance application determines when an advertisement break is initiated and/or terminated and does not rely on advertisement breaks scheduled by a content provider. Instead, the media guidance application processes data (e.g., indicating the attentiveness of a user) in order to determine whether or not to initiate an advertisement break. Dynamic advertisement breaks may be particularly useful in cases in which the media asset does not have prescheduled advertisement breaks (e.g., On-Demand programming), or the media guidance application must reschedule an advertisement that was missed due to a low attentiveness level of a user during the time when the advertisement was initially scheduled to be displayed.

To determine when an advertisement break is initiated and/or terminated, the media guidance application may process one or more types of data related to the characteristics and actions of users in in the viewing area of the display device associated with the media guidance application. As stated above, the media guidance application may use a detection module (e.g., detection module 316 (FIG. 3)) to detect when the attentiveness of the user reaches a threshold level (e.g., indicating that a user is interested and/or enjoying a media asset). The media guidance application may additionally or alternatively use a detection module to determine if a threshold number of users are present in the viewing area. For example, the media guidance application may not initiate an advertisement break if no users are currently in the viewing area, even if the media asset is currently displayed.

The media guidance application may also determine whether or not to terminate an advertisement break based on the number of users in the viewing area or the attentiveness level of the users. For example, if the attentiveness level of the users decreases (e.g., the users stop paying attention to the display device while advertisements are being displayed), or the number of users in the viewing area decreases (e.g., users leave the viewing area while the advertisements are being displayed), the media guidance application may continue the display of one or more advertisement until the attentiveness level of the users or the number of users in the viewing area increases. Additionally or alternatively, in response to the attentiveness level of the users or the number of users in the viewing area decreasing during the advertisement break (e.g., while the advertisements are displayed), the media guidance may terminate the advertisement break and/or rescheduled the advertisement break (e.g., at a predetermined time or at a time when the attentiveness level of the users or the number of users in the viewing area increases).

Additionally or alternatively, the detection module may also detect other user actions that may initiate an advertisement or compensate an advertisement provider for a lower user attentiveness level. For example, if the media guidance application determines that a user is currently accessing another media asset on a second device, the media guidance application may initiate an advertisement on the first device (e.g., display device 212) if the content of the advertisement is similar (e.g., relates to the same subject matter, product, genre, etc.) to the advertisement ready for display on the first display device. For example, the lower attentiveness level of the user (e.g., resulting from the user being distracted by the second device) may be compensated by the fact that the media guidance application can determine (e.g., via matching the advertisement content displayed on the first device to the media asset content displayed on the second device) that the user is interested in the content of the advertisement displayed on the first display.

Additionally and alternatively, an advertisement rule associated with an advertisement may define that the advertisement should only be displayed upon verification of a user's interest in the subject matter of the advertisement. For example, the advertisement provider may wish to verify that a user is likely to be interested in their product before authorizing an advertisement to be displayed (e.g., in order to reduce costs associated with advertising). Therefore, the advertisement of a car maker may have an advertisement rule requiring verification of a user's interest in buying a car. For example, the media guidance application, using a detection module (e.g., detection module 316 (FIG. 3)), may query the search history associated with a search engine accessed from a second device (e.g., a smartphone or tablet computer) being used by a user within the viewing area of the display device (e.g., display device 212). Upon detecting that the user previously searched for car buying information, the media guidance application may determine that the advertisement rule has been met and display the advertisement. In another example, the media guidance application, using a detection module (e.g., detection module 316 (FIG. 3)), may analyze keywords (e.g., “car,” “buying,” “auto-loan,” etc.) within a conversation between users (e.g., user 202, user 204, user 206, user 208, and user 210) occurring within the viewing area (e.g., viewing area 200) of a display device (e.g., display device 212). If any of the keywords describe an interest in buying a car (e.g., as determined by a cross-reference with a database indicating words indicative of an interest in buying a new car), the media guidance application may determine that the advertisement rule has been met and display (e.g., via issuing an instruction using control circuitry 304 (FIG. 3)) the advertisement.

The media guidance application may also receive (e.g., via detection module 316 (FIG. 3)) user generated data (e.g., status updates, microblog posts, etc.) describing a media asset and/or advertisement. Based on the user generated data, the media guidance application may initiate or terminate the display of a media asset and/or advertisement. For example, if a user posts an update to a social media website that he/she is currently enjoying a media asset, the media guidance application may initiate an advertisement (as the user is indicating a high attentiveness level) or delay a scheduled advertisement (in order not to disrupt the enjoyment of the media asset by the user). Likewise, if a user posts an update to a social media website that he/she is not currently enjoying a media asset (e.g., a post indicting the media asset is boring), the media guidance application may initiate an advertisement (e.g., in order to offer the user a distraction from the media asset) or delay a scheduled advertisement (in order to not further annoy an already ambivalent user).

The media guidance application may also determine whether or not to initiate or terminate an advertisement break based on the occurrences in the progression of the media asset. For example, the media guidance application may detect scene changes, segment or chapter endings (e.g., as typically found on a DVD), fades-to-black, transitions from one program to another, or other indicia of an appropriate time to initiate an advertisement break. At which point, the media guidance application may retrieve advertisement data, including an advertisement rule, in order to determine whether or not to transmit an instruction to display a particular advertisement (e.g., as discussed in relation to FIG. 7 below).

Based on the techniques and methods discussed above and below, the media guidance application may deliver unique media and advertisement experience to each display device. For example, the users in viewing area 100 (FIG. 1) may enjoy a completely different media and advertisement experience from the users in viewing area 200 (e.g., one set of users may receive different advertisements and advertisement breaks at different points in the progression of the media asset than the other set of users). In both scenarios, the media guidance application customizes the media assets and/or advertisement, including when the media assets and advertisements were initiated and/or terminated, based on the characteristics and actions of the user. Therefore, the media guidance application delivers more relevant advertisements and in a more efficient manner than traditional systems and methods.

FIG. 3 is a block diagram of an illustrative user equipment device in accordance with some embodiments of the disclosure. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media application stored in memory (i.e., storage 308). Specifically, control circuitry 304 may be instructed by the media application to perform the functions discussed above and below. For example, the media application may provide instructions to control circuitry 304 to generate the media guidance displays. In some implementations, any action performed by control circuitry 304 may be based on instructions received from the media application.

In client-server based embodiments, control circuitry 304 may include communications circuitry suitable for communicating with a media application server or other networks or servers. The instructions for carrying out the above mentioned functionality may be stored on the media application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and media application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive advertisement data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

User equipment device 300 may also incorporate or be accessible to detection module 316. Detection module 316 may further include various components (e.g., a video detection component, an audio detection component, etc.). In some embodiments, detection module 316 may include components that are specialized to generate particular information.

For example, as discussed below in relation to FIG. 5, detection module 316 may include an eye contact detection component, which determines or receives a location upon which one or both of a user's eyes are focused. The location upon which a user's eyes are focused is referred to herein as the user's “gaze point.” In some embodiments, the eye contact detection component may monitor one of both eyes of a user of user equipment 300 to identify a gaze point on display 312 for the user. The eye contact detection component may additionally or alternatively determine whether one or both eyes of the user are focused on display 312 (e.g., indicating that a user is viewing display 312) or focused on a location that is not on display 312 (e.g., indicating that a user is not viewing display 312). In some embodiments, the eye contact detection component includes one or more sensors that transmit data to processing circuitry 306, which determines a user's gaze point. The eye contact detection component may be integrated with other elements of user equipment device 300, or the eye contact detection component, or any other component of detection module 316 and may be a separate device or system in communication with user equipment device 300.

The media application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media application is a client-server based application. Data for use by a thick or thin client implemented on user equipment device 300 is retrieved on-demand by issuing requests to a server remote to the user equipment device 300. In one example of a client-server based media application, control circuitry 304 runs a web browser that interprets web pages provided by a remote server.

In some embodiments, the media application is downloaded and interpreted or otherwise run by an interpreter or virtual machine (run by control circuitry 304). In some embodiments, the media application may be encoded in the ETV Binary Interchange Format (EBIF), received by control circuitry 304 as part of a suitable feed, and interpreted by a user agent running on control circuitry 304. For example, the media application may be an EBIF application. In some embodiments, the media application may be defined by a series of JAVA-based files that are received and run by a local virtual machine or other suitable middleware executed by control circuitry 304. In some of such embodiments (e.g., those employing MPEG-2 or other digital media encoding schemes), the media application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media application may have the same layout on various different types of user equipment or may be tailored to the display capabilities of the user equipment. For example, on user computer equipment 404, the media application may be provided as a website accessed by a web browser. In another example, the media application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media application settings across in-home devices and remote devices. Settings include those described herein, as well as channel and program favorites, programming preferences that the media application utilizes to make programming recommendations, display preferences, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the media application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and advertisement data source 418 coupled to communications network 414 via communication paths 420 and 422, respectively. Paths 420 and 422 may include any of the communication paths described above in connection with paths 408, 410, and 412. Communications with the content source 416 and advertisement data source 418 may be exchanged over one or more communications paths, but are shown as a single path in FIG. 4 to avoid overcomplicating the drawing. In addition, there may be more than one of each of content source 416 and advertisement data source 418, but only one of each is shown in FIG. 4 to avoid overcomplicating the drawing. (The different types of each of these sources are discussed below.) If desired, content source 416 and advertisement data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Advertisement data source 418 may provide advertisement data, such as the advertisement rules associated with an advertisement. Data necessary for the functioning of the media application may be provided to the user equipment devices using any suitable approach. In some embodiments, the media application may be a stand-alone interactive television program guide that receives program guide data via a data feed (e.g., a continuous feed or trickle feed). Program schedule data and other advertisement data may be provided to the user equipment on a television channel sideband, using an in-band digital signal, using an out-of-band digital signal, or by any other suitable data transmission technique. Program schedule data and other advertisement data may be provided to user equipment on multiple analog or digital television channels.

In some embodiments, advertisement data from advertisement data source 418 may be provided to users' equipment using a client-server approach. For example, a user equipment device may pull advertisement data from a server, or a server may push advertisement data to a user equipment device. In some embodiments, a media application client residing on the user's equipment may initiate sessions with source 418 to obtain advertisement data when needed, e.g., when the advertisement data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Advertisement data source 418 may provide user equipment devices 402, 404, and 406 the media application itself or software updates for the media application.

Media applications may be, for example, stand-alone applications implemented on user equipment devices. For example, the media application may be implemented as software or a set of executable instructions which may be stored in storage 308, and executed by control circuitry 304 of a user equipment device 300. In some embodiments, media applications may be client-server applications where only a client application resides on the user equipment device, and server application resides on a remote server. For example, media applications may be implemented partially as a client application on control circuitry 304 of user equipment device 300 and partially on a remote server as a server application (e.g., advertisement data source 418) running on control circuitry of the remote server. When executed by control circuitry of the remote server (such as advertisement data source 418), the media application may instruct the control circuitry to generate the media application displays and transmit the generated displays to the user equipment devices. The server application may instruct the control circuitry of the advertisement data source 418 to transmit data for storage on the user equipment. The client application may instruct control circuitry of the receiving user equipment to generate the media application displays.

Content and/or advertisement data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may transfer only IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide advertisement data described above. In addition to content and/or advertisement data, providers of OTT content can distribute media applications (e.g., web-based applications or cloud-based applications), or the content can be displayed by media applications stored on the user equipment device.

Media guidance system 400 is intended to illustrate a number of approaches, or network configurations, by which user equipment devices and sources of content and advertisement data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media application implemented on a remote device. For example, users may access an online media application on a website via personal computers at their offices, or mobile devices such as a PDA or web-enabled mobile telephone. The user may set various settings (e.g., recordings, reminders, or other settings) on the online media application to control the user's in-home equipment. The online guide may control the user's equipment directly, or by communicating with a media application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media application to communicate directly with content source 416 to access content. Specifically, within a home, users of user television equipment 402 and user computer equipment 404 may access the media application to navigate among and locate desirable content. Users may also access the media application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more advertisement data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally stored content.

The media application may incorporate, or have access to, one or more content capture devices or application, such as camcorders, digital cameras with video mode, audio recorders, mobile phones, and handheld computing devices, to generate data describing the attentiveness level of a user. The user can upload data describing the attentiveness level of a user to a content storage service on the cloud either directly, for example, from user computer equipment 404 or wireless user communications device 406 having a content capture feature. Alternatively, the user can first transfer the content to a user equipment device, such as user computer equipment 404. The user equipment device storing the data describing the attentiveness level of a user uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

FIG. 5 is an illustrative example of one component of a detection module, which may be accessed by a media application in accordance with some embodiments of the disclosure. FIG. 5 shows eye contact detection component 500, which may be used to identify the gaze point of a user of user equipment 300, in order to determine the attentiveness level of the user. Eye contact detection component 500 includes processor 502, light source 504, and optical sensor 506. Light source 504 transmits light that reaches at least one eye of a user, and optical sensor 506 is directed at the user to sense reflected light. Optical sensor 506 transmits collected data to processor 502, and based on the data received from optical sensor 506, processor 502 determines a user's gaze point.

In some embodiments, eye contact detection component 500 is configured for determining a gaze point of a single user. In other embodiments, eye contact detection component 500 may determine gaze points for a plurality of users (e.g., user 102, user 104, user 106, user 108, and user 110 (FIG. 1)). Eye contact detection component 500 may identify multiple users of user equipment device 300.

Processor 502 may be integrated with one or more light sources 504 and one or more optical sensors 506 in a single device. Additionally or alternatively, one or more light sources 504 and one or more optical sensors 506 may be housed separately from processor 502 and in wireless or wired communication with processor 502. One or more of processors 502, light sources 504, and optical sensors 506 may be integrated into user equipment device 300.

Processor 502 may be similar to processing circuitry 306 described above. In some embodiments, processor 502 may be processing circuitry 306, with processing circuitry 306 in communication with light source 504 and optical sensor 506. In other embodiments, processor 502 may be separate from but optionally in communication with processing circuitry 306.

Light source 504 transmits light to one or both eyes of one or more users. Light source 504 may emit, for example, infrared (IR) light, near infrared light, or visible light. The light emitted by light source 504 may be collimated or non-collimated. The light is reflected in a user's eye, forming, for example, the reflection from the outer surface of the cornea (i.e. a first Purkinje image), the reflection from the inner surface of the cornea (i.e. a second Purkinje image), the reflection from the outer (anterior) surface of the lens (i.e. a third Purkinje image), and/or the reflection from the inner (posterior) surface of the lens (i.e. a fourth Purkinje image).

Optical sensor 506 collects visual information, such as an image or series of images, of one or both of one or more users' eyes. Optical sensor 506 transmits the collected image(s) to processor 502, which processes the received image(s) to identify a glint (i.e. corneal reflection) and/or other reflection in one or both eyes of one or more users. Processor 502 may also determine the location of the center of the pupil of one or both eyes of one or more users. For each eye, processor 502 may compare the location of the pupil to the location of the glint and/or other reflection to estimate the gaze point. Processor 502 may also store or obtain information describing the location of one or more light sources 504 and/or the location of one or more optical sensors 506 relative to display 312. Using this information, processor 502 may determine a user's gaze point on display 312, or processor 502 may determine whether or not a user's gaze point is on display 312.

In some embodiments, eye contact detection component 500 performs best if the position of a user's head is fixed or relatively stable. In other embodiments, eye contact detection component 500 is configured to account for a user's head movement, which allows the user a more natural viewing experience than if the user's head were fixed in a particular position.

In some embodiments accounting for a user's head movement, eye contact detection component 500 includes two or more optical sensors 506. For example, two cameras may be arranged to form a stereo vision system for obtaining a 3D position of the user's eye or eyes; this allows processor 502 to compensate for head movement when determining the user's gaze point. The two or more optical sensors 506 may be part of a single unit or may be separate units. For example, user equipment device 300 may include two cameras used as optical sensors 506, or eye contact detection component 500 in communication with user equipment device 300 may include two optical sensors 506. In other embodiments, each of user equipment device 300 and eye contact detection component 500 may include an optical sensor, and processor 502 receives image data from the optical sensor of user equipment device 300 and the optical sensor of eye contact detection component 500. Processor 502 may receive data identifying the location of optical sensor 506 relative to display 312 and/or relative to each other and use this information when determining the gaze point.

In other embodiments accounting for a user's head movement, eye contact detection component 500 includes two or more light sources for generating multiple glints. For example, two light sources 504 may create glints at different locations of an eye; having information on the two glints allows the processor to determine a 3D position of the user's eye or eyes, allowing processor 502 to compensate for head movement. Processor 502 may also receive data identifying the location of light sources 504 relative to display 312 and/or relative to each other and use this information when determining the gaze point.

In some embodiments, other types of eye contact detection components that do not utilize a light source may be used. For example, optical sensor 506 and processor 502 may track other features of a user's eye, such as the retinal blood vessels or other features inside or on the surface of the user's eye, and follow these features as the eye rotates. Any other equipment or method for determining one or more users' gaze point(s) not discussed above may be used in addition to or instead of the above-described embodiments of eye contact detection component 500.

It should be noted that eye contact detection component 500 is but one type of component that may be incorporated into or accessible by detection module 316 (FIG. 3) or the media application. Other types of components, which may generate other types of data (e.g., video, audio, textual, etc.) are fully within the bounds of this disclosure.

FIG. 6 is an illustrative example of a data structure that may be used to transmit data generated by the media application that is associated with an attentiveness level of a user in accordance with some embodiments of the disclosure. For example, data structure 600 may represent data generated by one or more components of detection module 316 (FIG. 3) such as eye contact detection component 500 (FIG. 5). In some embodiments, the media application may process data structure 600 to determine whether or not to transmit an instruction to display an advertisement as discussed below in relation to FIG. 7. For example, data structure 600 may be processed by control circuitry 304 (FIG. 3) as instructed by a media application implemented on user equipment 402, 404, and/or 406 (FIG. 4), content source 416 (FIG. 4), and/or any device accessible by communications network 414 (FIG. 4).

Data structure 600 includes multiple fields, which, in some embodiments, may include one of more lines of code for describing data and issuing instructions. For example, fields 602 through 620 indicate to the media application that data structure 600 relates to a media asset. It should be noted that the data (e.g., represented by the various fields) displayed in data structure 600 is not limiting, and in some embodiments, the data as described in data structure 600 may be replaced or supplemented by other data as discussed in the disclosure.

Fields 602 through 610 relate to data describing the attentiveness level of a first user (e.g., user 102 (FIG. 1)) as generated by the media application, for example, via a detection module (e.g., detection module 316 (FIG. 3)) within a viewing area (e.g., viewing area 100 (FIG. 1)) associated with a display device (e.g., display device 112 (FIG. 1)). For example, field 604 indicates to the media application that the first user (e.g., user 102 (FIG. 1)) is making eye contact with the display device (e.g., display device 112 (FIG. 1)) displaying a media asset. Field 606 indicates to the media application that the first user is currently engaged in a conversation with another user (e.g., user 106 (FIG. 1)). Field 608 indicates to the media application that the first user is not using a second device (e.g., a smartphone or tablet computer).

Fields 612 through 620 relate to data describing the attentiveness level of a second user (e.g., user 104 (FIG. 1)) generated by the media application, for example, via a detection module (e.g., detection module 316 (FIG. 3)) within a viewing area (e.g., viewing area 100 (FIG. 1)). For example, field 614 indicates to the media application that the second user is making eye contact with the display device (e.g., display device 112 (FIG. 1)) displaying a media asset. Field 606 indicates to the media application that the second user is not currently engaged in a conversation with another user. Field 618 indicates to the media application that the second user is not currently using a second device.

The media application may use the information in data structure 600 to compute an attentiveness level associated with each user (e.g., as described in relation to FIG. 7). For example, the media application may increase the attentiveness level of the first user and second user upon determining (e.g., based on field 604 and field 608) that the first user is making eye contact with the display device (e.g., display device 112 (FIG. 1)) and not using a second device. The media application may also decrease the attentiveness level of the first user upon determining (e.g., based on field 606) that the user is currently engaged in a conversation with another user. Furthermore, the media application may determine that the attentiveness level of the second user is higher than the attentiveness level of the first user because the second user (e.g., as indicated by field 616) is not currently engaged in a conversation with another user.

FIG. 7 is a flowchart of illustrative steps for determining whether or not to transmit an instruction to display an advertisement based on a comparison of a attentiveness level of a user and a threshold attentiveness level associated with the advertisement in accordance with some embodiments of the disclosure. Process 700 may be used to determine whether or not to transmit an advertisement (e.g., for display on display device 112 (FIG. 1)) based on the attentiveness level of the users. It should be noted that process 700 or any step thereof could be provided by any of the devices shown in FIGS. 3-4. For example, process 700 may be executed by control circuitry 304 (FIG. 3) as instructed by the media application.

At step 702, the media application generates data associated with an attentiveness level of a user accessing a display device. For example, the media application may use a detection module (e.g., detection module 316 (FIG. 3), which may be incorporated into or accessible by one or more content capture devices. Data captured by the content capture devices may be processed via a content recognition module or algorithm to generate data (e.g., regarding whether or not the user is making eye contact with the display device) describing the attentiveness of a user. In some embodiments, the data describing the attentiveness of a user may be recorded in a data structure (e.g., data structure 600 (FIG. 6)), which may be transmitted from the detection module to the media application.

At step 704, the media application determines the attentiveness level of the user based on the generated data. For example, as discussed in depth in relation to FIG. 8, the media application may process data describing the attentiveness of a user. In some embodiments, the media application (e.g., via control circuitry 304 (FIG. 3)) may process a data structure (e.g., data structure 600 (FIG. 6)), which includes data describing the attentiveness of a user to determine an attentiveness level for each user (e.g., user 102 (FIG. 1)) within a viewing area (e.g., viewing area 100 (FIG. 1)).

Additionally or alternatively, the media application may cross-reference the generated data in a database indicative of an attentiveness level of a user in order to determine an attentiveness level to associate with the user. For example, the media application may generate a data structure (e.g., data structure 600 (FIG. 6)) describing the attentiveness of a user. The data structure may then be transmitted to a remote server (e.g., advertisement data source 418 (FIG. 4)) to be cross-referenced in a database. Based on the cross-reference, the remote server may transmit an attentiveness level to associate with the user to the media application.

At step 706, the media application retrieves advertisement data associated with an advertisement that includes an advertisement rule indicating a threshold attentiveness level required for display of the advertisement. For example, the media application may have access to an advertisement data database (e.g., advertisement data source 418 (FIG. 4)) associated with one or more advertisements. In order to retrieve advertisement data such as an advertisement rule, the media application may query the database of advertisement data (e.g., via an instruction issued by control circuitry 304 (FIG. 3)). In some embodiments, the advertisement data may be located at a local database (e.g., storage 308 (FIG. 3) on user equipment device 402, 404, and/or 406 (FIG. 4)). In some embodiments, the media application may periodically, upon detecting an advertisement break, or on a continuous basis, request advertisement data from the database.

In some embodiments, the retrieve advertisement data may include one or more advertisement rules. For example, a first advertisement rule may indicate the threshold attentiveness level of a user necessary for display of the advertisement. The second advertisement rule may indicate the threshold number of users necessary for display of the advertisement. Additional advertisement rules may indicate the look or feel of the advertisement when it is displayed. For example, an advertisement rule may indicate that if a particular number of users are present, a particular version of the advertisement should be displayed.

At step 708, the media application compares the determined attentiveness level to the threshold attentiveness level. For example, a computed attentiveness level may represent a numerical amount or score. In such an example, the threshold attentiveness level would also be transmitted as a score featuring the same units of measure. The media application (e.g., via control circuitry 304 (FIG. 4)) may then determine whether or not the attentiveness level of the user (e.g., user 102 (FIG. 1)) equals or exceeds the threshold attentiveness level of the user.

If the media application determines that the attentiveness level exceeds the threshold attentiveness level, the media application (e.g., via control circuitry 304 (FIG. 3)) may transmit an instruction to display the advertisement on the display device (e.g., display device 112 (FIG. 1)) at step 710. In some embodiments, if the media application determines that the attentiveness level does not exceed the threshold attentiveness level, the media application (e.g., via control circuitry 304 (FIG. 3)) may transmit an instruction not to display the advertisement and/or retrieve another advertisement rule associated with another advertisement, which may have a different threshold attentiveness level.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method.

FIG. 8 is a flowchart of illustrative steps for determining an attentiveness level of a user in accordance with some embodiments of the disclosure. Process 800 may be used to determine whether or not to transmit an advertisement based on the attentiveness level of the users. For example, in some embodiments, process 800 may be used in process 700 (FIG. 7) to generate data associated with an attentiveness level of a user accessing a display device (e.g., step 702 (FIG. 7)) and determine an attentiveness level of the user based on the generated data (e.g., step 706 (FIG. 7)). It should be noted that process 800 or any step thereof could be provided by any of the devices shown in FIGS. 3-4. For example, process 800 may be executed by control circuitry 304 (FIG. 3) as instructed by the media application.

At step 802, the media application initiates an analysis of the attentiveness of a user. In some embodiments, the media application may issue an instruction (e.g., via control circuitry 304 (FIG. 3)) to a detection module (e.g., detection module 316 (FIG. 316)) to generate data describing the attentiveness level of the user (e.g., user 102 (FIG. 1)) in a viewing area (e.g., viewing area 100 (FIG. 1)).

For example, in response to receiving an instruction from the media application, a detection module (e.g., detection module 316 (FIG. 3)) may instruct one or more of its components to generate one or more types of data. For example, in response to an instruction from the media application (e.g. via control circuitry 304 (FIG. 3)) or the detection module, an eye contact detection component (e.g., eye contact detection component 500 (FIG. 5)) may generate data describing whether or not a user is making eye contact with the display device (e.g., display device 112 (FIG. 1)) displaying a media asset and/or advertisement.

At step 804, the media application receives data associated with eye contact of the user. For example, in some embodiments, data describing the attentiveness of a user may be recorded/transmitted in a data structure (e.g., data structure 600 (FIG. 6)). In some embodiments, the data structure may be generated by the detection module (e.g., detection module 316 (FIG. 3)) from transmission to the media application.

At step 806, the media application (e.g., via control circuitry 304 (FIG. 3)) determines an eye contact score based on the data associated with the eye contact of the user. For example, the media application may assign a value to the eye contact of the user (e.g., one point if the user is currently making eye contact and zero points if the user is not currently making eye contact).

At step 808, the media application adds the eye contact score to the computed attentiveness level of the user. For example, in some embodiments, the media application may receive several types of data associated with the attentiveness of a user (e.g., from one or more components of detection module 316 (FIG. 3)) and individual scores/values may be assigned to each time of data. The media application may then add the scores/values of the different types of data to generate an attentiveness level associated with the user.

At step 810, the media application determines whether or not the user is currently engaged in a conversation. For example, the media application may receive data (e.g., generated using speech recognition techniques discussed above), which indicate that the user is speaking to another user. In some embodiments, the data may be transmitted in a data structure (e.g., data structure 600 (FIG. 6)), which indicates (e.g., field 606 (FIG. 6)) whether or not the user is engaged in a conversation. Data related to whether or not the user is currently engaged in conversation may then be used by the media application to determine an attentiveness level of the user.

If the media application determines (e.g., via processing data structure 600 (FIG. 6)) that the user is currently engaged in a conversation, the media application, at step 814, decreases (e.g., by an increment of value used to compute the attentiveness level of the user) the attentiveness level of the user because speaking to another user may distract the user from the media asset and/or advertisement displayed on the display device (e.g., display device 112 (FIG. 1)). If the media application determines (e.g., via processing data structure 600 (FIG. 6)) that the user is not currently engaged in a conversation, the media application, at step 812, maintains the attentiveness level of the user because the user is less likely to be distracted from the media asset and/or advertisement displayed on the display device (e.g., display device 112 (FIG. 1)).

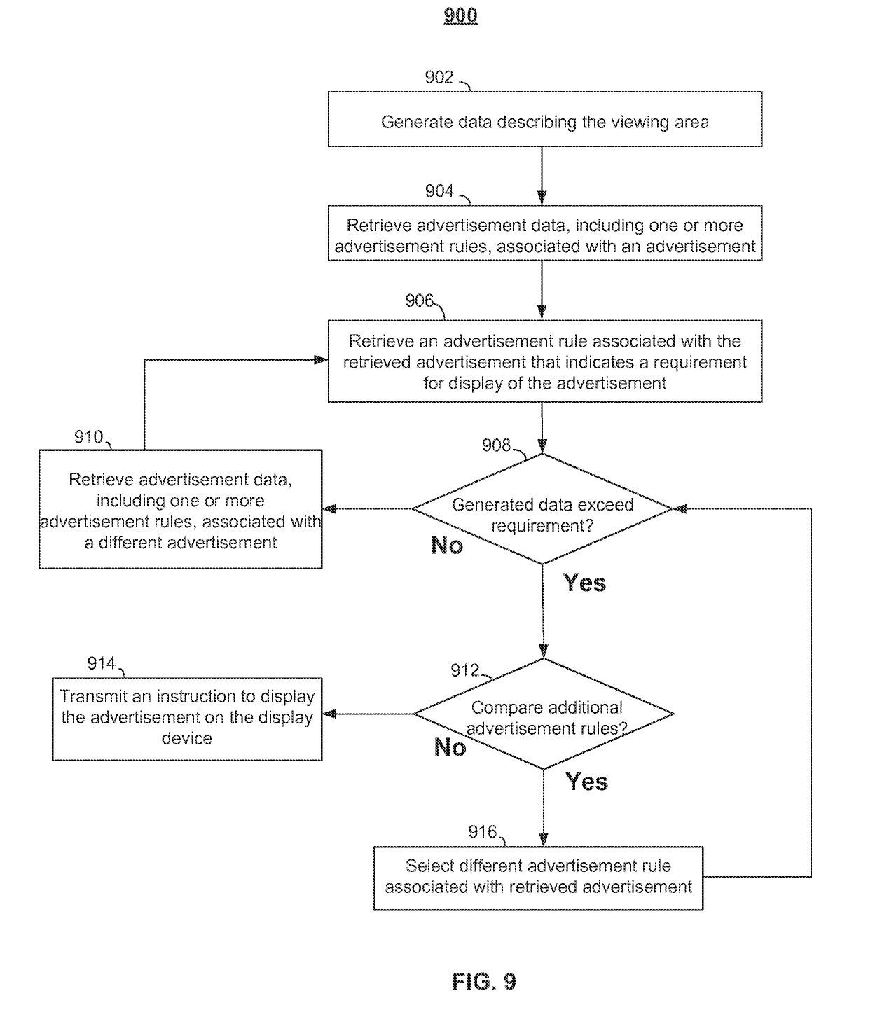

At step 816, the media application determines the attentiveness level of the user. For example, as discussed above, the media application may receive multiple types of data describing the attentiveness of the user. The media application (e.g., via control circuitry 304 (FIG. 3)) may process (e.g., via assigning a value and adding the values together) each type of data to determine an attentiveness level associated with the user. The attentiveness level of the user may then be used to determine whether or not to transmit an instruction to display an advertisement as discussed in relation to FIGS. 7 and 9.

At step 818, the media application determines whether or not there are additional users present in the viewing area (e.g., viewing area 100 (FIG. 1)). If so, the media application proceeds to step 820, selects a different user, and returns to step 802. If the media application determines there are no additional users present, the media application proceeds to step 822 and determines a composite attentiveness level for the users.

For example, in some embodiments, an advertisement rule may require a threshold attentiveness level associated with all users (e.g., user 102, user 104, user 106, user 108, and user 110 (FIG. 1)) in a viewing area (e.g., viewing area 112 (FIG. 1)). In such cases, the media application may need to determine a composite attentiveness level. In some embodiments, the composite attentiveness level may represent a suitable statistical measurement (e.g., mean, mode, median, etc.) associated with the combined attentiveness level of each user in the viewing area. For example, if one user in a viewing area has an attentiveness level of fifty and another user in the viewing area has an attentiveness level of sixty, the composite attentiveness level may be the average (fifty-five) of the two individual attentiveness levels.

It is contemplated that the steps or descriptions of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method.

FIG. 9 is a flowchart of illustrative steps for determining whether or not to transmit an instruction to display an advertisement based on interpreting one or more advertisement rules associated with the advertisement. For example, in some embodiments, process 900 may be used in process 700 (FIG. 7) to compare the determined attentiveness level to the threshold attentiveness level (e.g., step 702 (FIG. 7)) and transmit an instruction to display the advertisement on the display device in response to determining the attentiveness level exceeds the threshold attentiveness level (e.g., step 706 (FIG. 7)). It should be noted that process 900 or any step thereof could be provided by any of the devices shown in FIGS. 3-4. For example, process 900 may be executed by control circuitry 304 (FIG. 3) as instructed by the media application.

At step 902, the media application generates user data describing the viewing area. For example, in some embodiments, the media application may determine the attentiveness level of the user. For example, the media application may generate data indicating that a user in the viewing area (e.g., viewing area 100 (FIG. 1)) of a display device (e.g., display device 112 (FIG. 1)) displaying a media asset and/or advertisement is currently accessing another media asset and/or advertisement on a second device. Based on the received data, the media application may associate a particular value of an attentiveness level with the user as discussed in relation to FIGS. 7 and 8. Additionally or alternatively, the media application may cross-reference the generated data in a database indicative of an attentiveness level of a user that is currently accessing another media asset and/or advertisement on a second device to determine an attentiveness level to associate with the user.

At step 904, the media application retrieves advertisement data including one or more advertisement rules. For example, the media application may have access to an advertisement data database (e.g., advertisement data source 418 (FIG. 4)) associated with one or more advertisements that it may query (e.g., via an instruction issued by control circuitry 304 (FIG. 3)) in order to retrieve advertisement data associated with an advertisement. In some embodiments, the advertisement data may be located at a local (e.g., on storage 308 (FIG. 3) on user equipment device 402, 404, and/or 406 (FIG. 4)) or remote (e.g., any location accessible via communication database 414 (FIG. 4)) database.

In some embodiments, the media application may periodically query the advertisement database (e.g., upon detecting a scheduled advertisement break). In some embodiments, the media application may query the advertisement database upon determining a particular attentiveness level associated with a user (e.g., as determined in relation to process 800 (FIG. 8)).

At step 906, the media application may retrieve an advertisement rule associated with the retrieved advertisement that indicates a requirement for display of the advertisement. For example, the media application may process (e.g., via control circuitry 304 (FIG. 3)) the advertisement data to locate an advertisement rule in the advertisement data. In some embodiments, the advertisement rule may define a threshold level of attentiveness associated with a user, a threshold number of users present, or any of suitable criteria for determining whether or not to display an advertisement.

At step 908, the media application determines whether or not the generated data describing the viewing area exceeds the requirement for display of the advertisement. For example, the media application may determine whether or not a determined attentiveness level of the user equals or exceeds the required threshold attentiveness level. In some embodiments, the generated data may be compared to the requirements for displaying the advertisement as defined by the advertisement rule. For example, the advertisement rule may define a threshold attentiveness level for display of the advertisement. The media application may then compare the threshold attentiveness level to an attentiveness level of the user, computed by the media application (e.g., via one or more steps of process 800 (FIG. 8)) in the same units of measure as the threshold attentiveness level. The media application (e.g., via control circuitry 304 (FIG. 4)) may then determine, based on a comparison of the values (e.g., as described in relation to step 708 (FIG. 7)) whether or not the attentiveness level of the user equals or exceeds the threshold attentiveness level of the user.

If the attentiveness level of the user does not exceeds the threshold attentiveness level required for displaying the advertisement, the media application proceeds to step 910 and retrieves advertisement data (e.g., via control circuitry 304 (FIG. 3) querying an advertisement data source 418 (FIG. 4)), including one or more advertisement rules, associated with a different advertisement. The media application then returns to step 906. If the attentiveness level of the user does exceed the threshold attentiveness level required for displaying the advertisement, the media application proceeds to step 912.

At step 912, the media application determines whether or not it will compare additional advertisement rules. If not, the media application proceeds to step 914 and transmits an instruction (e.g., via control circuitry 304 (FIG. 3)) to display the advertisement on the display device. For example, in some embodiments, an advertisement may be associated with only a single rule. If the media application determines that it will compare additional advertisement rules (e.g., a required number of users present), the media application proceeds to step 916, selects a different advertisement rule associated with retrieved advertisement, and returns to step 908.

It is contemplated that the steps or descriptions of FIG. 9 may be used with any other embodiment of this disclosure. In addition, the steps and descriptions described in relation to FIG. 9 may be done in alternative orders or in parallel to further the purposes of this disclosure. For example, each of these steps may be performed in any order or in parallel or substantially simultaneously to reduce lag or increase the speed of the system or method.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method for monitoring users viewing media assets, the method comprising:
generating data associated with an attentiveness level of a user using a user device;
determining the attentiveness level of the user based on the generated data;
retrieving a first advertisement rule associated with an advertisement, wherein the first advertisement rule indicates a threshold attentiveness level required for display of the advertisement;
comparing the determined attentiveness level to the threshold attentiveness level; and
in response to determining the attentiveness level exceeds the threshold attentiveness level, transmitting an instruction to display the advertisement on a display device.

2. The method of claim 1, further comprising in response to determining the attentiveness level does not exceed the threshold attentiveness level, retrieving a different advertisement rule associated with a different advertisement.

3. The method of claim 1, further comprising in response to determining the determined attentiveness level exceeds the threshold attentiveness level, retrieving a second advertisement rule associated with the advertisement, wherein the second advertisement rule defines the look and feel of the advertisement.

4. The method of claim 1, further comprising:
generating user number data associated with a number of users within a viewing area of the user device;
determining the number of users within a viewing area of the user device based on the user number data;
retrieving a second advertisement rule associated with the advertisement, wherein the second advertisement rule indicates a threshold number of users required for display of the advertisement;
comparing the determined number of users to the threshold number of users;
in response to determining the determined number of users does not exceed the threshold number of users, transmitting an instruction to not display the advertisement on the display device and retrieve a different advertisement rule associated with a different advertisement.

5. The method of claim 1, wherein the first advertisement rule is associated with a plurality of advertisements that are displayed in series on the user device.

6. The method of claim 5, further comprising retrieving the plurality of advertisements, wherein each advertisement of the plurality of advertisements is associated with a different advertisement rule.

7. The method of claim 1, wherein the data associated with the attentiveness level of the user is one of data associated with whether or not the user is viewing the display device, data associated with whether the user is listening to the display device, data associated with whether the user is interacting with the display device, data associated with whether the user is interacting with another device, or data associated with whether the user is interacting with another user.

8. The method of claim 1, wherein generating data associated with an attentiveness level of a user using a user device, further comprises:
receiving data indicative of whether or not the user is engaged in a conversation with another user; and
in response to determining the user is engaged in a conversation with another user, decreasing the determined attentiveness level of the user.

9. The method of claim 1, wherein generating data associated with an attentiveness level of a user using a user device, further comprises:
receiving data indicative of whether or not the user is interacting with a second display device; and
in response to determining the user is interacting with a second display device, decreasing the determined attentiveness level of the user.

10. The method of claim 1, wherein generating data associated with an attentiveness level of a user using a user device, further comprises:
receiving data indicative of whether or not the user is making eye contact with the display device; and
in response to determining the user is making eye contact with the display device, increasing the determined attentiveness level of the user.

11. A system for monitoring users viewing media assets, the system comprising control circuitry configured to:
generate data associated with an attentiveness level of a user using a user device;
determining the attentiveness level of the user based on the generated data;
retrieve a first advertisement rule associated with an advertisement, wherein the first advertisement rule indicates a threshold attentiveness level required for display of the advertisement;
compare the determined attentiveness level to the threshold attentiveness level; and
in response to determining the attentiveness level exceeds the threshold attentiveness level, transmit an instruction to display the advertisement on a display device.

12. The system of claim 11, wherein the control circuitry is further configured to retrieve a different advertisement rule associated with a different advertisement in response to determining the attentiveness level does not exceed the threshold attentiveness level.

13. The system of claim 11, wherein the control circuitry is further configured to retrieve a second advertisement rule associated with the advertisement, wherein the second advertisement rule defines the look and feel of the advertisement in response to determining the determined attentiveness level exceeds the threshold attentiveness level.

14. The system of claim 11, wherein the control circuitry is further configured to:
generate user number data associated with a number of users within a viewing area of the user device;
determine the number of users within a viewing area of the user device based on the user number data;
retrieve a second advertisement rule associated with the advertisement, wherein the second advertisement rule indicates a threshold number of users required for display of the advertisement;
compare the determined number of users to the threshold number of users;
in response to determining the determined number of users does not exceed the threshold number of users, transmit an instruction to not display the advertisement on the display device and retrieve a different advertisement rule associated with a different advertisement.

15. The system of claim 11, wherein the first advertisement rule is associated with a plurality of advertisements that are displayed in series on the user device.

16. The system of claim 15, wherein the control circuitry is further configured to retrieve the plurality of advertisements, wherein each advertisement of the plurality of advertisements is associated with a different advertisement rule.

17. The system of claim 11, wherein the data associated with the attentiveness level of the user is one of data associated with whether or not the user is viewing the display device, data associated with whether the user is listening to the display device, data associated with whether the user is interacting with the display device, data associated with whether the user is interacting with another device, or data associated with whether the user is interacting with another user.

18. The system of claim 11, wherein the control circuitry configured to generate data associated with an attentiveness level of a user using a user device is further configured to:
receive data indicative of whether or not the user is engaged in a conversation with another user; and
in response to determining the user is engaged in a conversation with another user, decrease the determined attentiveness level of the user.

19. The system of claim 11, wherein the control circuitry configured to generate data associated with an attentiveness level of a user using a user device is further configured to:
receive data indicative of whether or not the user is interacting with a second display device; and
in response to determining the user is interacting with a second display device, decrease the determined attentiveness level of the user.

20. The system of claim 11, wherein the control circuitry configured to generate data associated with an attentiveness level of a user using a user device is further configured to:
receive data indicative of whether or not the user is making eye contact with the display device; and
in response to determining the user is making eye contact with the display device, increase the determined attentiveness level of the user.

21-30. (canceled)
